(19) United States
(12) Patent Application Publication
(10) Pub. No.: US 2012/0067782 A1
(43) Pub. Date: Mar. 22, 2012

(54) HYDROGEN SULFIDE SCAVENGER COMPOSITIONS, METHODS FOR MAKING AND PROCESSES FOR REMOVING HYDROGEN SULFIDE FROM LIQUID HYDROCARBON MEDIA

(76) Inventors: Gregory KAPLAN, The Woodlands, TX (US); Larry John Karas, Spring, TX (US)

(21) Appl. No.: 12/886,695

(22) Filed: Sep. 21, 2010

(51) Int. Cl. C10G 29/22; C09K 3/00

(52) U.S. Cl. 208/240; 252/396

(57) ABSTRACT

A method for reducing the amount of hydrogen sulfide present in liquid hydrocarbon media while minimizing the amount of corrosion in processing equipment contacting the liquid hydrocarbon media. The method includes neutralizing a glyoxal solution and dispersing the neutralized glyoxal solution in the liquid hydrocarbon media. The neutralized glyoxal solution is dispersed within the liquid hydrocarbon media not more than 10 days after the glyoxal solution has been neutralized. A hydrogen sulfide scavenging composition and method for making are also provided.

### FIELD OF THE INVENTION

This invention relates generally to processing liquid hydrocarbon media, and more particularly, to methods and scavenger compositions for removing hydrogen sulfide from liquid hydrocarbon media.

### BACKGROUND OF THE INVENTION

Hydrocarbon media may contain hydrogen sulfide, which is highly corrosive and poisonous in very small concentrations. The risk of exposure to hydrogen sulfide from handling hydrocarbon media is a health and safety concern during storage, transportation (shipping, truck or pipeline) and processing. Hydrogen sulfide is extremely reactive causing corrosion to equipment and, especially in refinery applications, poisons the catalysts downstream of the refinery process.

It is essential to remove hydrogen sulfide from hydrocarbon media before processing. One type of hydrogen sulfide scavenger that is available commercially is glyoxal. During production of glyoxal, acidic byproducts are often formed or added. These byproducts, while essential for long-term stability and storage of glyoxal, can lead to increased corrosion rates during hydrocarbon processing. When glyoxal is added to a liquid hydrocarbon media, the acidic byproducts, which are not soluble in the liquid hydrocarbon media, can settle out from the liquid hydrocarbon media into a separate aqueous phase. For example, the aqueous phase may run along the bottom of the processing or refinery equipment as small tributaries in pipelines or stagnate at the bottom of holding tanks. This acidic aqueous phase is highly corrosive and can cause troughing in the processing or refinery equipment.

What is needed is an improved method for removing hydrogen sulfide from a liquid hydrocarbon media without causing corrosion to processing equipment.

### BRIEF DESCRIPTION OF THE INVENTION

One embodiment of the invention provides for a method for reducing the amount of hydrogen sulfide present in a liquid hydrocarbon media while minimizing the amount of corrosion in processing equipment contacting the liquid hydrocarbon media, said method comprises neutralizing a glyoxal solution and dispersing the neutralized glyoxal solution in the liquid hydrocarbon media, wherein the neutralized glyoxal solution is dispersed within the liquid hydrocarbon media not more than 10 days after the glyoxal solution has been neutralized.

In another embodiment, a hydrogen sulfide scavenging composition includes glyoxal and a neutralizer and has a pH of at least about 5.0. [0007] An alternate embodiment provides a process for making a hydrogen sulfide scavenging composition including neutralizing a glyoxal solution with neutralizing agents to a pH of at least about 5.0. [0008] The various embodiments provide an improved hydrogen scavenging process for liquid hydrocarbon media that reduces hydrogen sulfide while minimizing corrosion to processing equipment.

### DETAILED DESCRIPTION OF THE INVENTION

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

The modifier “about” used in connection with a quantity is inclusive of the stated value and has the meaning dictated by the context (e.g., includes the tolerance ranges associated with measurement of the particular quantity).

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

In one embodiment of the invention, a method is taught for reducing the amount of hydrogen sulfide present in a liquid hydrocarbon media while minimizing the amount of corrosion in processing equipment contacting the liquid hydrocarbon media, said method includes neutralizing a glyoxal solution and dispersing the neutralized glyoxal solution in the liquid hydrocarbon media, wherein the neutralized glyoxal solution is dispersed within the liquid hydrocarbon stream not more than 10 days after the glyoxal solution has been neutralized.

Any amount of hydrogen sulfide in the liquid hydrocarbon media may be reduced and the actual amount of residual hydrogen sulfide will vary depending on the starting amount. In one embodiment, the hydrogen sulfide levels are reduced to about 150 ppm by volume or less, as measured in the vapor phase, based on the volume of the liquid hydrocarbon media. In another embodiment, the hydrogen sulfide levels are reduced to 100 ppm by volume or less, as measured in the vapor phase, based on the volume of the liquid hydrocarbon media. In another embodiment, the hydrogen sulfide levels are reduced to 50 ppm by volume or less, as measured in the vapor phase, based on the volume of the liquid hydrocarbon media. And in a further embodiment, the hydrogen sulfide levels are reduced to 20 ppm by volume or less, as measured in the vapor phase, based on the volume of the liquid hydrocarbon media.

The liquid hydrocarbon media may be any type of liquid hydrocarbon media containing hydrogen sulfide. The liquid hydrocarbon media includes, but is not limited to, crude oil, heavy oil, processed residual oil, bitmunious, coker oils, coker gas oils, fluid catalytic cracker feeds, gas oil, naphtha, FCC slurry, diesel fuel, fuel oil, jet fuel, gasoline, kerosene or vacuum residua. One embodiment provides for the liquid hydrocarbon media to be at an elevated temperature. In another instance, the liquid hydrocarbon media may be at a temperature of from about ambient to about 150° C. In an alternate embodiment, the liquid hydrocarbon media may be at a temperature of from about 40° C. to about 100° C.

The processing equipment in contact with the liquid hydrocarbon media may be any type of equipment that can be used for processing the liquid hydrocarbon media, such as pipelines, refineries, cargo vessels, storage vessels or holding tanks. Processing equipment subject to corrosion is generally processing equipment made of steel or alloys, such as carbon steel, but any type of processing equipment may be protected.

A neutralized glyoxal solution can be dispersed in the liquid hydrocarbon media while in contact with the processing equipment to reduce the hydrogen sulfide and protect the processing equipment from corrosion.

The neutralized glyoxal solution may include glyoxal and a neutralizing agent. Glyoxal is a water-soluble aldehyde and may include oligomers of glyoxal. Glyoxal is commercially available as a 40 weight percent aqueous solution.

The neutralizing agent may be any type of chemical compound that is capable of reacting with a strong acid and increases the pH of the glyoxal solution to a pH of at least about 5.0. Alternately, the pH of the glyoxal solution may be increased to a pH in the range of from about 5.0 to about 14.0. In another embodiment, the pH of the glyoxal solution is increased to a pH in the range of from about 5.0 to about 10.0. In another embodiment, the pH of the glyoxal solution is increased to a pH in the range of from about 5.0 to about 7.0. The neutralizing agent may be a base, including, but not limited to, alkali metal oxides or hydroxides, alkali metals of weak acids or amines. In another embodiment, the neutralizing agent may be a polymeric material capable of forming bonds with the acidic impurites in the glyoxal solution, and in another embodiment, the alkali metal oxide may be calcium oxide. In analternate embodiment, the alkali metal hydroxide may be sodium hydroxide, or, the alkali metal of a weak acid may be calcium carbonate. In one embodiment, an amine may be triethanolamine. In another embodiment, the polymeric material may be an ion exchange resin.

The neutralizing agent is added in an effective amount to neutralize the glyoxal solution by adjusting the glyoxal solution to a pH of at least about 5.0. In one embodiment, the amount of neutralizing agent is from about 0.1 percent by weight to about 50 percent by weight, based on the weight of the glyoxal solution. In another embodiment, the neutralizing agent is present from about 0.1 percent by weight to about 25 percent by weight, based on the weight of the glyoxal solution. The neutralizing agent may be present from about 0.1 percent by weight to about 10 percent by weight, based on the weight of the glyoxal solution. In another embodiment, the neutralizing agent is present from about 0.1 percent by weight to about 1 percent by weight, based on the weight of the glyoxal solution.

The neutralizing agent may be blended with the glyoxal solution in any conventional manner. In one embodiment, a container with a neutralizing agent may be placed into a feeding line adding glyoxal solution into a liquid hydrocarbon media. In one embodiment, the neutralizing agents may be in cartridges or packed in columns and the glyoxal solution may be pumped through the packed columns or cartridges. In another embodiment, the neutralizing agent may be added directly to the glyoxal solution.

The neutralized glyoxal solution may be dispersed in the liquid hydrocarbon media in any conventional manner. In one embodiment, the neutralized glyoxal solution may be delivered in metered amounts into the liquid hydrocarbon media. In another embodiment, a feeding system may be used to add the neutralized glyoxal solution to the liquid hydrocarbon media. The feeding system may include a pump and a storage container. In another embodiment, the neutralized glyoxal solution may be injected into the liquid hydrocarbon media by a conventional in-line injection system and may be injected at any point in-line suitable to allow the glyoxal solution to mix with the liquid hydrocarbon media. The neutralized glyoxal solution may be added to the liquid hydrocarbon media in a continuous manner or can be added in one or more batch modes and repeated additions may be made.

The neutralized glyoxal solution may be added to the liquid hydrocarbon media in any amount sufficient to reduce the levels of hydrogen sulfide in the liquid hydrocarbon media. In one embodiment, the neutralized glyoxal solution may be added in an amount of from about 1 ppm to about 3000 ppm by volume, based on the volume of the liquid hydrocarbon media. In another embodiment, the neutralized glyoxal solution may be added in an amount of from about 10 ppm by volume to about 2000 ppm by volume, based on the volume of the liquid hydrocarbon media. In another embodiment, the neutralized glyoxal solution may be added in an amount of from about 50 ppm by volume to about 1500 ppm by volume, based on the weight of the liquid hydrocarbon media. In another embodiment, the neutralized glyoxal solution may be added in an amount of from about 100 ppm by volume to about 1200 ppm by volume, based on the volume of the liquid hydrocarbon media.

The neutralized glyoxal solution may be dispersed into the liquid hydrocarbon media in any conventional manner. In one embodiment, the neutralized glyoxal solution may be mixed or blended into the liquid hydrocarbon media. In another embodiment, the neutralized glyoxal solution may be dispersed within the liquid hydrocarbon media as the hydrocarbon media is transported through a pipe or tube.

In one embodiment, the neutralized glyoxal solution is dispersed within the liquid hydrocarbon stream not more than 10 days after the glyoxal solution has been neutralized. The glyoxal solution contains acidic by-products and has a low pH value in the range of about 2 to about 3, which can be very corrosive to processing equipment. The glyoxal solution can be neutralized, but side-reactions begin to occur at higher pH values where the glyoxal begins to react with other glyoxal compounds to produce acids and alcohols. These side-reactions diminish the glyoxal actives and continue at a high rate until the pH falls to a stable pH value of at least about 5.0. The glyoxal solution may be neutralized to a pH value in the range of from about 5.0 to about 14.0, but the solution must be used within a period of 10 days to maintain the higher pH value of the solution and the glyoxal actives. In one embodiment, the neutralized glyoxal solution is dispersed within the liquid hydrocarbon media immediately upon neutralizing the glyoxal solution. In another embodiment, the neutralized glyoxal solution is dispersed within the liquid hydrocarbon media within 240 hours of neutralizing the glyoxal solution. In another embodiment, the neutralized glyoxal solution is dispersed within the liquid hydrocarbon media within 96 hours. In another embodiment, the neutralized glyoxal solution is dispersed within 48 hours. In another embodiment, the neutralized glyoxal solution is dispersed within the liquid hydrocarbon media within 36 hours. In another embodiment, the neutralized glyoxal solution is dispersed within 24 hours. In another embodiment, the neutralized glyoxal solution is dispersed within 12 hours. In another embodiment, the neutralized glyoxal solution is dispersed within 8 hours. In another embodiment, the neutralized glyoxal solution is dispersed within 2 hours. In another embodiment, the neutralized glyoxal solution is dispersed within 1 hour.

In another embodiment, a hydrogen sulfide scavenging composition includes a glyoxal solution and a neutralizer and has a pH of at least about 5.0. A hydrogen sulfide scavenging composition reduces hydrogen sulfide levels in liquid hydrocarbon media and has a pH in the range of at least about 5.0, which reduces the corrosiveness of the glyoxal and protects the processing equipment.

The glyoxal solution and neutralizing agent are described above. The neutralizing agent is added in an effective amount to adjust the glyoxal solution to a pH of at least about 5.0. In another embodiment, the pH of the glyoxal solution is increased to a pH in the range of from about 5.0 to about 14.0. In another embodiment, the pH of the glyoxal solution is increased to a pH in the range of from about 5.0 to about 10.0. In another embodiment, the pH of the glyoxal solution is increased to a pH in the range of from about 5.0 to about 7.0.

In one embodiment, the amount of neutralizing agent is from about 0.1 percent by weight to about 5 percent by weight, based on the weight of the glyoxal solution. In another embodiment, the neutralizing agent is present from about 0.5 percent by weight to about 5 percent by weight, based on the weight of the glyoxal solution. In another embodiment, the neutralizing agent is present from about 1 percent by weight to about 5 percent by weight, based on the weight of the glyoxal solution.

In another embodiment, a process for making a hydrogen sulfide scavenging composition includes neutralizing a glyoxal solution with neutralizing agents to a pH of at least about 5.0. The neutralizing agent is added in an effective amount to adjust the glyoxal solution to a pH of at least about 5.0. In another embodiment, the pH of the glyoxal solution is increased to a pH in the range of from about 5.0 to about 14.0. In another embodiment, the pH of the glyoxal solution is increased to a pH in the range of from about 5.0 to about 10.0. In another embodiment, the pH of the glyoxal solution is increased to a pH in the range of from about 5.0 to about 7.0. In one embodiment, the amount of neutralizing agent is added to the glyoxal solution from about 0.1 percent by weight to about 5 percent by weight, based on the weight of the glyoxal solution. In another embodiment, the neutralizing agent is added to the glyoxal solution in an amount of from about 0.5 percent by weight to about 5 percent by weight, based on the weight of the glyoxal solution. In another embodiment, the neutralizing agent is added to the glyoxal solution in an amount of from about 1 percent by weight to about 5 percent by weight, based on the weight of the glyoxal solution. The neutralizing agent and glyoxal solution are as described above. [0029] The neutralizing agent may be added to the glyoxal solution in any conventional manner. In one embodiment, a container with a neutralizing agent may be placed into a feeding line adding glyoxal solution into a liquid hydrocarbon media. In one embodiment, the neutralizing agents may be in cartridges or packed in columns and the glyoxal solution is pumped through the packed columns or cartridges. In another embodiment, the neutralizing agent is added directly to the glyoxal solution.

In one embodiment, a catalyst may be added to the glyoxal solution to enhance the removal of the hydrogen sulfide. In one embodiment, the catalyst is a quaternary ammonium salt. The catalyst may be any suitable quaternary ammonium salt. In one embodiment, the catalyst has formula I:

R₁R₂R₃R₄N⁺X⁻ I

wherein R₁, R₂, R₃ and R₄ are each independently an alkyl group having from 1 to 30 carbon atoms, an aryl group having from 6 to 30 carbon atoms or an arylalkyl group having from 7 to 30 carbon atoms; and X is a halide, sulfate, nitrate or carboxylate. The alkyl groups and the aryl groups may be substituted or unsubstituted.

In one embodiment, R₁ is an alkyl group having from 1 to 24 carbon atoms. In one embodiment, R₂ is an alkyl having from 1 to 24 carbon atoms, an aryl group having from 6 to 24 carbon atoms or an arylalkyl group having from 7 to 24 carbon atoms.

In one embodiment, R₃ and R₄ are each, independently, an alkyl group having from 1 to 24 carbon atoms. In another embodiment, R₃ and R₄ are each, independently, an alkyl group having from 1 to 4 carbon atoms.

The alkyl group includes, but is not limited to, methyl, ethyl, propyl, isopropyl, butyl, isobutyl, pentyl, hexyl, decyl or dodecyl. The aryl group may be phenyl. The arylalkyl group include may be benzyl. The halide may be chloride, bromide or iodide. The sulfate may be a methyl sulfate. The carboxylate may be acetate.

In one embodiment, the quaternary ammonium salt is alkyl benzyl ammonium chloride or benzyl cocoalkyl(C₁₂-C₁₈)dimethylammonium chloride. In another embodiment, the quaternary ammonium salt includes, but is not limited to dicocoalkyl (C₁₂-C₁₈)dimethylammonium chloride, ditallowedimethylammonium chloride, di(hydrogenated tallow alkyl)dimethyl quaternary ammonium methyl chloride, methyl bis(2-hydroxyethyl cocoalkyl(C₁₂-C₁₈) quaternary ammonium chloride, dimethyl(2-ethyl) tallow ammonium methyl sulfate, n-dodecylbenzyldimethylammonium chloride, n-octadecylbenzyldimethyl ammonium chloride, n-dodecyltrimethylammonium sulfate, soya alkyltrimethylammonium chloride or hydrogenated tallow alkyl (2-ethylhyexyl) dimethyl quaternary ammonium methyl sulfate.

In one embodiment, the catalyst is present from about 0.01 to about 15 percent by weight based on the weight of glyoxal. In another embodiment, the catalyst is present from about 1 to about 10 percent by weight based on the weight of glyoxal.

The catalyst may be added to the liquid hydrocarbon media simultaneously with the glyoxal solution or may be added separately from the glyoxal solution. In one embodiment, the catalyst is preblended with the glyoxal solution before being added to the liquid hydrocarbon media. The catalyst may be added to the glyoxal solution before the solution is neutralized, simultaneously with the addition of the neutralizing agents or after the glyoxal solution is neutralized.

In order that those skilled in the art will be better able to practice the present disclosure, the following examples are given by way of illustration and not by way of limitation.

### EXAMPLES

### Example 1

100 g of a 40% weight glyoxal solution having a pH of 2 was blended with 0.4 g of TEA (triethanolamine). The pH was measured at 6.

### Example 2

100 g of a 40% weight glyoxal solution having a pH of 2 was blended with 1 g of a 10% weight sodium hydroxide solution. The pH was measured in a range of from about 6 to about 7.

### Example 3

8 g of a 40% weight glyoxal solution having a pH of 2 was stirred with 2 g of Amberlite IRA-400 (OH form) resin, which is an ion exchange resin manufactured by Rohm & Haas (Midland, Mich.). The pH was measured in a range of from about 6 to about 7.

### Example 4

100 g of a 40% weight glyoxal solution having pH of 2.18 was blended with 0.57 g of TEA. The pH was measured at 6.94. The neutralized mixture was stored at room temperature in a closed container and pH measurements were taken at various times and shown in Table 1.

TABLE 1

| Time in storage after being neutralized | | pH value |
|---|---|---|
| 24 | hours | 6.71 |
| 72 | hours | 6.34 |
| 6 | days | 5.94 |
| 10 | days | 5.51 |

### Example 5

100 g of a 40% weight glyoxal solution having pH of 2.18 was blended with 2.0 g of 10% weight solution of sodium hydroxide. The pH was measured at 6.92. The neutralized mixture was stored at room temperature in a closed container and pH measurements were taken at various times and shown in Table 2.

TABLE 2

| Time in storage after being neutralized | | pH value |
|---|---|---|
| 24 | hours | 6.15 |
| 72 | hours | 5.55 |
| 6 | days | 5.15 |
| 10 | days | 5.01 |

While typical embodiments have been set forth for the purpose of illustration, the foregoing descriptions should not be deemed to be a limitation on the scope herein. Accordingly, various modifications, adaptations and alternatives may occur to one skilled in the art without departing from the spirit and scope herein.

Having described the invention that which is claimed is:

1. A method for reducing the amount of hydrogen sulfide present in a liquid hydrocarbon media while minimizing the amount of corrosion in processing equipment contacting the liquid hydrocarbon media, said method comprising neutralizing a glyoxal solution and dispersing the neutralized glyoxal solution in the liquid hydrocarbon media, wherein the neutralized glyoxal solution is dispersed within the liquid hydrocarbon media not more than 10 days after the glyoxal solution has been neutralized.

2. The method of claim 1 wherein the liquid hydrocarbon media is selected from the group consisting of crude oil, heavy oil, processed residual oil, bituminous, coker oils, coker gas oil, fluid catalytic cracker feeds, gas oil, naphtha, FCC slurry, diesel fuel, fuel oil, jet fuel, gasoline, kerosene and vacuum residua.

3. The method of claim 1 wherein the liquid hydrocarbon media is at an elevated temperature.

4. The method of claim 3 wherein the liquid hydrocarbon media is at a temperature of from about ambient to about 150° C.

5. The method of claim 1 wherein the processing equipment is a pipeline or a holding tank.

6. The method of claim 5, wherein the processing equipment is made of carbon steel.

7. The method of claim 1, wherein the neutralized glyoxal solution has a pH of at least about 5.0.

8. The method of claim 7, wherein the neutralized glyoxal solution is prepared by adding a neutralizer to the glyoxal solution, wherein said neutralizer is selected from the group consisting of alkali metal oxides, alkali metal hydroxides, alkali metals of weak acids, amines and ion-exchange resins.

9. The method of claim 8, wherein the amount of neutralizer is from about 0.1 percent by weight to about 5 percent by weight, based on the weight of the glyoxal solution.

10. The method of claim 8, wherein the neutralizer is placed into a feeding line adding a glyoxal solution into liquid hydrocarbon media.

11. The method of claim 1, wherein the neutralized glyoxal solution is added to the liquid hydrocarbon media in an amount of from about 1 ppm to about 3000 ppm by volume, based on the volume of the liquid hydrocarbon media.

12. The method of claim 8, wherein the neutralizer is in a cartridge or column and the glyoxal solution is pumped through the cartridge or column to produce a neutralized glyoxal solution.

13. The method of claim 1, wherein the neutralized glyoxal solution is delivered continuously to the hydrocarbon media in metered amounts.

14. The method of claim 1, wherein the glyoxal solution further comprises a catalyst.

15. The method of claim 14, wherein the catalyst is a quaternary ammonium salt.

16. The method of claim 15, wherein the catalyst has formula I:
R₁R₂R₃R₄N⁺X⁻I
wherein R₁, R₂, R₃ and R₄ are each independently an alkyl group having from 1 to 30 carbon atoms, an aryl group having from 6 to 30 carbon atoms or an arylalkyl group having from 7 to 30 carbon atoms; and X is a halide, sulfate, nitrate or carboxylate.

17. The method of claim 16, wherein the quaternary ammonium salt is alkyl benzyl ammonium chloride or benzyl cocoalkyl(C₁₂-C₁₈)dimethylammonium chloride.

18. The method of claim 16, wherein the catalyst is present from about 0.01 to about 15 percent by weight based on the weight of glyoxal.

19. A hydrogen sulfide scavenging composition comprising glyoxal and a neutralizer and has a pH of at least about 5.0.

20. The scavenging composition of claim 19, wherein the composition has a pH in the range of from about 5.0 to about 14.0.

21. The scavenging composition of claim 19, wherein the neutralizer is selected from the group consisting of alkali metal oxides, alkali metal hydroxides, alkali metals of weak acids, amines and ion-exchange resins.

22. The scavenging composition of claim 19, wherein the amount of neutralizer is from about 0.1 percent by weight to about 5 percent by weight, based on the weight of the glyoxal solution.

23. The scavenging composition of claim 19, wherein the glyoxal further comprises a catalyst.

24. A process for making a hydrogen sulfide scavenging composition comprising neutralizing a glyoxal solution with neutralizing agents to a pH of at least about 5.0.

25. The process of claim 24 wherein the scavenging composition has a pH in the range of from about 5.0 to about 14.0.

26. The process of claim 24, wherein the neutralizer is present from about 0.1 percent by weight to about 5 percent by weight, based on the weight of the glyoxal solution.

27. The process of claim 24, wherein the neutralizer is selected from the group consisting of alkali metal oxides, alkali metal hydroxides, alkali metals of weak acids, amines and ion-exchange resins.

28. The process of claim 24, wherein the neutralizer is in a cartridge or column and the glyoxal solution is pumped through the cartridge or column to produce a neutralized glyoxal solution.

29. The process of claim 24, wherein the composition further comprises a catalyst.
